(19) United States
(12) Patent Application Publication
(10) Pub. No.: US 2007/0188837 A1
(43) Pub. Date: Aug. 16, 2007

(54) Beam expanding optical element, beam expansion method, image display apparatus, and head-mounted display

(75) Inventors: Yoshie Shimizu, Ibaraki-shi (JP); Takeshi Endo, Osaka-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/703,299

(22) Filed: Feb. 7, 2007

(30) Foreign Application Priority Data
Feb. 16, 2006 (JP) 2006-038819

(51) Int. Cl. G03H 1/00

(52) U.S. Cl. 359/13

(57) ABSTRACT

A first HOE and a second HOE are respectively arranged on two opposite faces of an optical waveguide member. The first HOE diffracts light incident from the outside on the optical waveguide member such that the light is then totally reflected inside the optical waveguide member and is thereby directed to the second HOE. The second HOE diffracts, according to the diffraction efficiency thereof, part of the light incident thereon after being guided inside the optical waveguide member such that this part of the light is then emitted to the outside substantially parallel to the light incident on the optical waveguide member, and the second HOE simultaneously totally reflects the rest of the light incident thereon. The second HOE repeats such emission and total reflection. The first and second HOEs each have interference fringes with n different pitches (where n is a natural number equal to or greater than two) to diffract light of n different wavelengths at substantially equal angles. Thus, even when light of n different wavelengths is incident on the optical waveguide member, the second holographic diffractive optical element emits it to the outside with substantially equal pitches for the light of the n different wavelengths.

This application is based on Japanese Patent Application No. 2006-038819 filed on Feb. 16, 2006, the contents of which are hereby incorporated by reference.

### BACKGROUND OF THE INVENTION

1. Field of the Invention

The present invention relates to: a beam expanding optical element that expands the beam diameter of the light incident thereon and then emits it; a beam expansion method associated therewith; an image display apparatus provided with such a beam expanding optical element; and a head-mounted display (hereinafter also referred to as “HMD”) provided with such an image display apparatus.

2. Description of Related Art

There have conventionally been proposed various beam expanding optical elements that expand the beam diameter of the light incident thereon and then emit it. For embodiment, in the optical element disclosed in U.S. Pat. No. 6,580,529 B1, light incident on an optical waveguide member is diffracted and thereby reflected by three diffractive elements one after another so that the light is eventually emitted with its beam diameter expanded two-dimensionally.

This optical element can be used with no problem with light of a single color; when used with light of a wide wavelength width, however, it disadvantageously produces color unevenness (chromatic dispersion). Specifically, the longer the wavelength of the light incident on the first diffractive element, the larger the angle of emergence (angle of diffraction) from the diffractive element. Hence, when the light, after being totally reflected inside the optical waveguide member, is diffracted by the last diffractive element and is thereby emitted, the pitch between the emission positions at which the light is emitted is the greater the longer its wavelength. This produces color unevenness.

To prevent this, in the optical element disclosed in U.S. Pat. No. 6,805,490 B2, three optical waveguide plates are laid together, with two thin films having a lower index of refraction than the optical waveguide plates laid in between. This certainly helps eliminate the color unevenness mentioned above.

Disadvantageously, however, with this optical element, to cope with the light of a color image represented by R, G, and B, at least three optical waveguide plates are needed that correspond to light of three colors, namely R, G, and B; in addition, two thin films need to be formed between those optical waveguide plates. Thus, the optical element has a five-layer structure, a complicated one that makes the optical element extremely expensive.

### SUMMARY OF THE INVENTION

In view of the conventionally experienced disadvantages mentioned above, it is an object of the present invention to provide: a beam expanding optical element that, despite having a simple structure, operates with reduced color unevenness; a beam expansion method associated therewith; an image display apparatus provided with such a beam expanding optical element; and a head-mounted display provided with such an image display apparatus.

To achieve the above object, according to one aspect of the invention, a beam expanding optical element is provided with: an optical waveguide member that has two mutually opposite faces that respectively have mutually parallel flat surfaces; a first holographic diffractive optical element arranged at one location on the flat surface of the optical waveguide member, the first holographic diffractive optical element diffracting the light incident from the outside on the optical waveguide member such that the light is then totally reflected inside the optical waveguide member; and a second holographic diffractive optical element arranged at another location on the flat surface of the optical waveguide member, the second holographic diffractive optical element diffracting, according to the diffraction efficiency thereof, part of the light incident thereon after being guided inside the optical waveguide member such that this part of the light is then emitted to the outside substantially parallel to the light incident on the optical waveguide member, the second holographic diffractive optical element simultaneously totally reflecting the rest of the light incident thereon. Here, the first and second holographic diffractive optical elements each have interference fringes with n different pitches (where n is a natural number equal to or greater than two) so as to diffract light of n different wavelengths at substantially equal angles.

With this structure, the first and second holographic diffractive optical elements are held at different locations on the flat surfaces of the optical waveguide member. The first holographic diffractive optical element diffracts the light incident from the outside on the optical waveguide member such that the light is then totally reflected inside the optical waveguide member. The second holographic diffractive optical element diffracts part of the light incident thereon after being guided inside the optical waveguide member such that this part of the light is then emitted to the outside substantially parallel to the light incident on the optical waveguide member; simultaneously, the second holographic diffractive optical element totally reflects the rest of the light incident thereon.

What has just been referred to as “the light incident thereon after being guided inside the optical waveguide member” includes not only the light that is diffracted by the first holographic diffractive optical element such that it then travels inside the optical waveguide member so as to be incident on the second holographic diffractive optical element for the first time but also the light that is totally reflected by the second holographic diffractive optical element such that it then travels inside the optical waveguide member so as to be incident on the second holographic diffractive optical element for the second and subsequent times. As a result of the second holographic diffractive optical element repeating emission of light to the outside and total reflection in this way, the beam diameter of the light emitted from the second holographic diffractive optical element to the outside is expanded compared with that of the light incident on the optical waveguide member.

Here, the first and second holographic diffractive optical elements each have interference fringes with n different pitches (where n is a natural number equal to or greater than two) so as to diffract light of n different wavelengths at substantially equal angles. Thus, even when light of n different wavelengths is incident on the optical waveguide member, the emission pitch of the light emitted from the second holographic diffractive optical element to the outside is substantially equal among light of the n different wavelengths. Hence, with a simple structure involving a plurality of holographic diffractive optical elements bonded to a single optical waveguide member, it is possible to reduce color unevenness (color dispersion). In addition, the use of a single optical waveguide member contributes to low cost.

According to another aspect of the invention, an image display apparatus is provided with: a light source; a display element that produces image light by modulating the light emitted from the light source; the above-described beam expanding optical element according to the invention; and an optical system that directs the image light from the display element to the beam expanding optical element. Here, the beam expanding optical element may include a third holographic diffractive optical element that diffracts the light diffracted by the first holographic diffractive optical element and then traveling inside the optical waveguide member such that the light is deflected toward where the second holographic diffractive optical element is arranged. The beam expanding optical element may have two second holographic diffractive optical elements and two third holographic diffractive optical elements, in which case the first holographic diffractive optical element diffracts the light incident from the display element thereon such that the light is then directed toward both of the two third holographic diffractive optical elements, and the third holographic diffractive optical elements respectively diffract the light diffracted by the first holographic diffractive optical element and then traveling inside the optical waveguide member such that the light is then directed toward where the corresponding second holographic diffractive optical elements are arranged.

The present invention may be expressed as follows. According to yet another aspect of the invention, a method for beam expansion involves: a step of diffracting, by using a first holographic diffractive optical element arranged on a flat surface on an optical waveguide member, light of n different wavelengths (where n is a natural number equal to or greater than two) incident thereon at substantially equal angles; a step of totally reflecting the light diffracted by the first holographic diffractive optical element so as to make the light travel inside the optical waveguide member; and a step of receiving the light traveling inside the optical waveguide member with a second holographic diffractive optical element so that the second holographic diffractive optical element diffracts part of the light so as to emit this part of the light to outside substantially parallel to incident light and that the second holographic diffractive optical element simultaneously totally reflect the rest of the light, the second holographic diffractive optical element diffracting the light of the n different wavelengths at substantially equal angles.

### BRIEF DESCRIPTION OF THE DRAWINGS

These and other objects and features of the present invention will be apparent from the following detailed description of preferred embodiments thereof taken in conjunction with the accompanying drawings, in which:

FIG. 1 is a cross-sectional view showing an outline of the structure of a beam expanding optical element as one embodiment of the invention;

FIG. 2 is a diagram schematically illustrating part of an exposure optical system used when a holographic diffractive optical element for the above beam expanding optical element is fabricated;

FIG. 3 is a plot showing the relationship between exposure amount and diffraction efficiency as observed when the above holographic diffractive optical element is fabricated;

FIG. 4 is a cross-sectional view showing an outline of the structure of a beam expanding optical element as another embodiment of the invention;

FIG. 5 is a diagram schematically illustrating part of an exposure optical system used when a holographic diffractive optical element for the above beam expanding optical element is fabricated;

FIG. 6 is a perspective view showing an outline of the structure of a beam expanding optical element as yet another embodiment of the invention;

FIG. 7 is a cross-sectional view showing an outline of the structure of an image display apparatus as yet another embodiment of the invention;

FIG. 8 is a plot showing the spectral intensity characteristics of a light source for the above image display apparatus;

FIG. 9A is a plan view showing an outline of the structure of an HMD as yet another embodiment of the invention;

FIG. 9B is a front view of the above HMD;

FIG. 10 is a perspective view showing an outline of the structure of an HMD as yet another embodiment of the invention;

FIG. 11 is a diagram schematically illustrating part of an exposure optical system used when a holographic diffractive optical element for a beam expanding optical element for use in the above HMD is fabricated;

FIG. 12A is a plan view showing another example of the structure of the above HMD; and

FIG. 12B is a plan view of the above HMD.

### DETAILED DESCRIPTION OF PREFERRED EMBODIMENTS

### Embodiment 1

An embodiment of the invention will be described below with reference to the accompanying drawings.

### 1. Structure of a Beam Expansion Optical Element

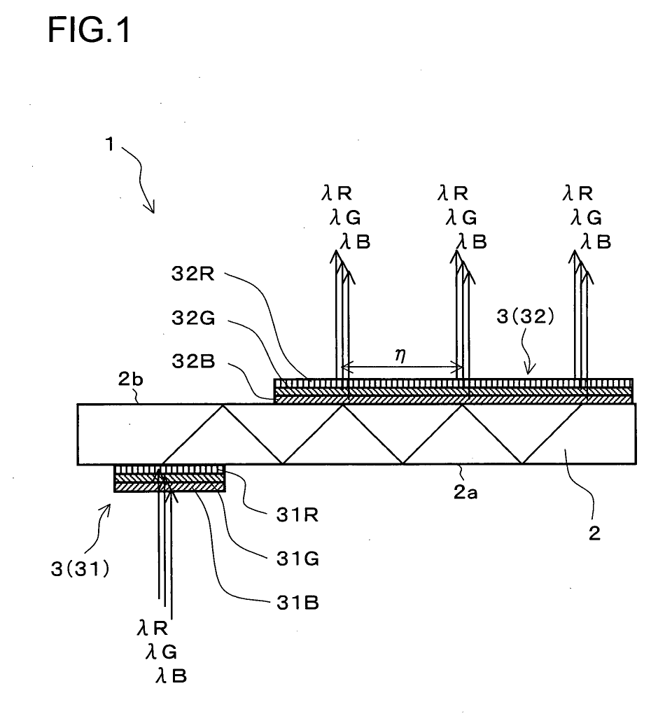

FIG. 1 is a cross-sectional view showing an outline of the structure of a beam expanding optical element 1 as a first embodiment of the invention. The beam expanding optical element 1 is an optical element that expands the beam diameter of the light incident thereon and then emits it. The beam expanding optical element 1 includes an optical waveguide member 2 and a plurality of volume-phase-type holographic diffractive optical elements 3.

In this embodiment, the optical waveguide member 2 is realized with a parallel plate; that is, the optical waveguide member 2 has two mutually opposite faces 2a and 2b, which have mutually parallel flat surfaces.

In this embodiment, the holographic diffractive optical elements 3 include two holographic diffractive optical elements, namely HOEs 31 and 32. In this embodiment, the HOEs 31 and 32 are both transmissive, and are arranged at different locations on the flat surfaces of the optical waveguide member 2. More specifically, the HOE 31 is held on the face 2a of the optical waveguide member 2, and the HOE 32 is held on the face 2b of the optical waveguide member 2.

The HOE 31 is a first holographic diffractive optical element that diffracts the light incident from the outside on the optical waveguide member 2 such that the light is then totally reflected inside the optical waveguide member 2. In this embodiment, the HOE 31 diffracts the incident light, for example, at 45° to guide it inside the optical waveguide member 2 toward the HOE 32.

Here, the HOE 31 is formed of, as hologram photosensitive materials, three types of sheet-form photopolymers 31R, 31G, and 31B that are laid together in this order from the face 2a side of the optical waveguide member 2, the three photopolymers 31R, 31G, and 31B having interference fringes recorded therein corresponding to R (red), G (green), and B (blue) respectively. The photopolymers 31R, 31G, and 31B have the interference fringes thereof recorded by exposure with such pitches as to diffract all the light of the corresponding wavelengths at substantially equal angles (for example, 45 degrees). Accordingly, the HOE 31 diffracts light in three wavelength bands, for example 465±5 nm (B light), 521±5 nm (G light), and 634±5 nm (R light) as represented in terms of their respective peak-diffraction-efficiency wavelengths and diffraction-efficiency half-peak wavelength widths, at substantially equal angles (for example, 45 degrees). The HOE 31 is designed to exhibit the maximum diffraction efficiency at the design principal wavelengths. Moreover, the HOE 31 is formed with a width greater than the emission pitch η of the light emitted from the HOE 32 to the outside. Here, the width of the HOE 31 denotes the width thereof as measured in the direction (light guide direction) in which the light traveling from the HOE 31 toward the HOE 32 is guided (the direction parallel to the faces 2a and 2b).

On the other hand, the HOE 32 is a second holographic diffractive optical element that diffracts, according to the diffraction efficiency thereof, part of the light incident thereon after being guided inside the optical waveguide member 2 such that this part of the light is then emitted to the outside parallel to the light incident on the optical waveguide member 2, and that simultaneously totally reflects the rest of the light incident thereon.

The HOE 32 is formed with a greater width than the HOE 31 at least in the above-mentioned light guide direction. Thus, the light incident on the HOE 32 after being guided inside the optical waveguide member 2 includes not only the light that is diffracted at an angle of 45 degrees by the HOE 31 such that it then travels inside the optical waveguide member 2 so as to be incident on the HOE 32 at an angle of 45 degrees for the first time but also the light that is totally reflected by the HOE 32 such that it then travels inside the optical waveguide member 2 and is then totally reflected on the face 2a so as to be incident on the HOE 32 at an angle of 45 degrees for the second and subsequent times.

The HOE 32 is formed of, as hologram photosensitive materials, three types of sheet-form photopolymers 32B, 32G, and 32R that are laid together in this order from the face 2b side of the optical waveguide member 2, the three photopolymers 32B, 32G, and 32R having interference fringes recorded therein corresponding to B, G, and R respectively. The photopolymers 32B, 32G, and 32R have the interference fringes thereof recorded by exposure with such pitches as to diffract all the light of the corresponding wavelengths at substantially equal angles (substantially parallel to the light incident from the outside on the optical waveguide member 2). Accordingly, the HOE 32 diffracts light in three wavelength bands, for example 465±5 nm (B light), 521±5 nm (G light), and 634±5 nm (R light) as represented in terms of their respective peak-diffraction-efficiency wavelengths and diffraction-efficiency half-peak wavelength widths, at substantially equal angles so that the light is then emitted to the outside parallel to the light incident on the optical waveguide member 2.

The diffraction efficiency of the HOE 32 is set to be higher the farther away from the HOE 31 along the optical path so that the intensity of the light emitted from the HOE 32 to the outside is constant irrespective of the position on the HOE 32. How the diffraction efficiency is set in that way will be described later.

### 2. How to Fabricate Holographic Diffractive Optical Elements

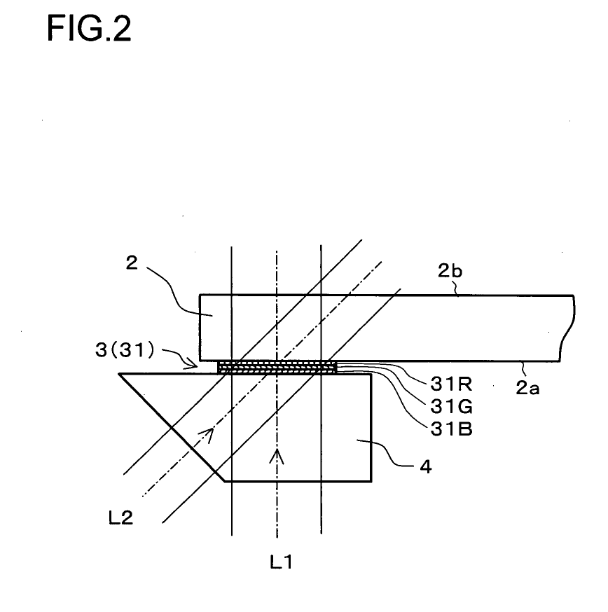

Next, how the holographic diffractive optical elements 3 (transmissive) used in this embodiment are fabricated will be described. FIG. 2 is a diagram schematically illustrating part of an exposure optical system used to fabricate the holographic diffractive optical elements 3. The following description deals with how the HOE 31 of the holographic diffractive optical elements 3 is fabricated. It should be understood that the HOE 32 is fabricated similarly.

First, the photopolymers 31R, 31G, and 31B are applied in this order at a predetermined location on the face 2a of the optical waveguide member 2, and the applied photopolymers are then placed at a predetermined position in the exposure optical system. On the other hand, R, G, and B laser light emitted from R, G, and B laser light sources is mixed into a single beam, and is then split with a half mirror or the like into two beams L1 and L2, which are then shone onto the photopolymers 31R, 31G, and 31B at predetermined angles as shown in FIG. 2. As a result, interference fringes produced by interference between the two beams L1 and L2 are recorded in the photopolymers 31R, 31G, and 31B in the form of index-of-refraction distributions.

Here, a light introducing prism 4 is arranged in contact with the photopolymer 31B, and the two beams L1 and L2 are shone onto the photopolymers 31R, 31G, and 31B through the light introducing prism 4. The light introducing prism 4 is arranged so that the face of the light introducing prism 4 through which the beam L1 enters it is perpendicular to the beam L1 and parallel to the faces 2a and 2b of the optical waveguide member 2, and that the face of the light introducing prism 4 through which the beam L2 enters it is perpendicular to the beam L2 and at 45 degrees to the faces 2a and 2b of the optical waveguide member 2.

As a result of the photopolymers 31R, 31G, and 31B being exposed through the light introducing prism 4 in this way, the HOE 31 is fabricated. When light from the outside is shone onto the thus fabricated HOE 31 along the same optical path as the beam L1, the HOE 31 diffracts the light incident thereon at the same angle as the direction in which the beam L2 travels, that is, at the angle (45 degrees) at which the light is then totally reflected inside the optical waveguide member 2.

In a case where the light introducing prism 4 is arranged as described above, it is necessary that the photopolymer 31B and the light introducing prism 4 be kept in intimate contact with each other by application of an emulsion fluid or the like between them so that no air gap is left.

Moreover, in a case where the HOE 31 occupies so large an area that the beam L2 transmitted through the photopolymers 31R, 31G, and 31B is totally reflected on the face 2b of the optical waveguide member 2 to reach the face 2a again within the region of the HOE 31, the total reflection on the face 2b needs to be prevented by arranging another prism (unillustrated) on the face 2b side of the optical waveguide member 2 to dispose of exposure light. In this case, it is also necessary that the optical waveguide member 2 and the prism be kept in intimate contact with each other by application of an emulsion fluid or the like between them so that no air gap is left.

The above description deals with a case where R, G, and B laser light is simultaneously shone onto the photopolymers 31R, 31G, and 31B; instead, it is also possible to shine the R, G, and B laser light in a temporally shifted fashion. Instead of applying all the photopolymers 31R, 31G, and 31B first and then shining R, G, and B laser light simultaneously, it is also possible to apply the photopolymers 31R, 31G, and 31B one after another, each time followed by the shining of laser light of the corresponding wavelength.

### 3. How to Set Diffraction Efficiency

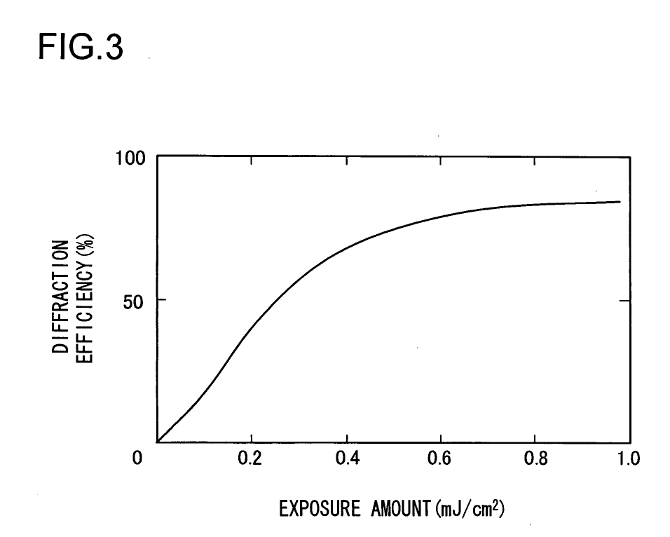

Next, how to set the diffraction efficiency of the HOE 32 will be described. FIG. 3 is a plot showing the relationship between exposure amount (exposure energy) and diffraction efficiency as generally observed when a HOE is fabricated. As this figure shows, the larger the exposure amount, the higher the diffraction efficiency until it is saturated over a predetermined energy. Accordingly, unless the diffraction efficiency is saturated, by adjusting the exposure amount, it is possible to control the diffraction efficiency of a HOE.

In this embodiment, as described above, the diffraction efficiency of the HOE 32 is set to be higher the farther away from the HOE 31 along the optical path. Such setting of diffraction efficiency can be achieved by adjusting exposure amount as described above. Specifically, for example, while the HOE 32 is being exposed, by moving a shuttering member from the HOE 31 toward the HOE 32 so as to thereby vary the duration for which the HOE 32 is irradiated with (exposed to) light according to the position thereon, it is possible to adjust the exposure amount according to the position on the HOE 32 so as to give the HOE 32 diffraction efficiency that increases as one goes farther away from the HOE 31.

Also, by previously setting the intensity distribution of the light used for exposure, and exposing the HOE 32 to the light thus having a prescribed intensity distribution, it is possible to give the HOE 32 diffraction efficiency that varies according to the position. For example, by expanding the beam diameter of the light to which the HOE 32 is exposed, and irradiating the HOE 32 with the light corresponding to the left half of the Gaussian distribution, it is possible to expose the part of the HOE 32 closer to the HOE 31 to light with lower intensity and the part of the HOE 32 farther from the HOE 31 to light with higher intensity. This gives the HOE 32 diffraction efficiency that increases as one goes farther away from the HOE 31.

It is also possible to set the diffraction efficiency of the HOE 32 as described above by adjusting the thicknesses and index-of-refraction modulation amounts Δn of the photopolymers 32R, 32G, and 32B

### 4. Workings and Effects

Next, the workings and effects of the beam expanding optical element 1 structured as described above will be described with reference to FIG. 1.

When light of R, G, and B wavelengths (λR, λG, and λB) is incident on the HOE 31 of the beam expanding optical element 1, it is all diffracted in the 45-degree direction by the HOE 31 so that it is then guided, by being totally reflected, inside the optical waveguide member 2 toward the HOE 32. Part of the light incident on the HOE 32 at an angle of 45 degrees for the first time is diffracted by the HOE 32, according to the diffraction efficiency thereof at the incidence position, so as to be emitted to the outside; the rest of the light, left undiffracted, is totally reflected by the HOE 32 so as to be further guided inside the optical waveguide member 2.

The light totally reflected by the HOE 32 is then totally reflected by the opposite face 2a of the optical waveguide member 2 so that it is then incident again on the HOE 32. In a similar manner as described above, part of the light incident on the HOE 32 is diffracted by the HOE 32, according to the diffraction efficiency thereof at the incidence position, so as to be emitted to the outside; the rest of the light, left undiffracted, is totally reflected by the HOE 32 so as to be further guided inside the optical waveguide member 2. Thereafter, each time light reaches the HOE 32, diffraction of part of the light and total reflection of the rest of the light are repeated.

The light emitted from a plurality of positions on the HOE 32 as described above is emitted from the HOE 32 at the same angle at which light from the outside is incident on the HOE 31 (that is, the emitted light is parallel to this light from the outside). Here, let m be a natural number equal to or greater than 2, and suppose that diffraction and total reflection by the HOE 32 occur m times, then the light incident on the HOE 31 is eventually emitted from the HOE 32 in m beams. That is, as a result of emission of light to the outside and total reflection being repeated at the HOE 32, the beam diameter of the light emitted from the HOE 32 to the outside is expanded compared with that of the light incident from the outside on the optical waveguide member 2. In this way, the light incident on the HOE 31 has the beam diameter thereof expanded to a size corresponding to the area of the HOE 32, and is then emitted from the HOE 32.

As described above, in this embodiment, the HOE 31 and 32 each have interference fringes with three different pitches so as to diffract light of three different, namely R, G, and B, wavelengths at substantially equal angles, and thus, when R, G, and B light is incident from the outside on the optical waveguide member 2, it all is diffracted at substantially equal angles by the HOE 31, then it all travels along substantially the same optical path, and it is then emitted from the HOE 32 to the outside. In this way, R, G, and B light travels along substantially the same optical path inside the optical waveguide member 2, and this permits the emission pitch η of the light emitted from the HOE 32 to the outside to be substantially equal among R, G, and B light.

Thus, it is possible to emit light having substantially the same wavelength characteristics as incident light to the outside, with no deviations in emission position due to differences in color. In addition, instead of laying a plurality of optical waveguide plates together as conventionally practiced, simply by bonding a plurality of HOEs 31 and 32 to a single optical waveguide member 2, it is possible to reduce color unevenness (color dispersion), and thus it is possible to cope with a wide band of wavelengths easily. Moreover, since only a single optical waveguide member 2 is needed, it is possible to fabricate the beam expanding optical element 1 at low cost.

Here, from the viewpoint of reducing color unevenness in the light emitted from the HOE 32, it can be said that the emission pitch η of the light emitted from the HOE 32 to the outside has simply to be equal at least between light of two different wavelengths. Accordingly, the HOEs 31 and 32 have simply to have interference fringes with two different pitches corresponding to two of the R, G, and B wavelengths. That is, let n be a natural number equal to or greater than 2, the HOEs 31 and 32 have simply to have interference fringes with n different pitches so as to diffract light of n different wavelengths at substantially equal angles.

Moreover, in this embodiment, the HOE 32 is formed with a greater width than the HOE 31 in the direction in which the light traveling from the HOE 31 toward the HOE 32 is guided; in addition, the HOE 32 diffracts, according to the diffraction efficiency thereof, part of the light that is totally reflected by the HOE 32, is then totally reflected by the opposite face 2a of the optical waveguide member 2, and is then incident again on the HOE 32, the HOE 32 simultaneously totally reflecting the rest of the light. Thus, emission of light to the outside and total reflection are repeated a plurality of times at the HOE 32. This permits the beam diameter of the light emitted from the HOE 32 to the outside to be surely expanded compared with that of the light incident from the outside on the optical waveguide member 2.

Moreover, the HOE 31 is formed with a width greater than the emission pitch η of the light emitted from the HOE 32 to the outside. If the width of the HOE 31 is smaller than the emission pitch η, the beam diameter of the light introduced through the HOE 31 into the optical waveguide member 2 is so small that the light guided inside the optical waveguide member 2 so as to be incident on the HOE 32 is incident thereon only over part of the incidence face (diffractive face) thereof. As a result, in the intensity distribution of the light emitted from the HOE 32, there appear discrete high-intensity positions corresponding to the different emission positions, making the intensity distribution uneven.

In contrast, in this embodiment, since the HOE 31 is given a width greater than the emission pitch η, when light with a beam diameter substantially equal to the width of the HOE 31 is incident on the HOE 31, the light guided inside the optical waveguide member 2 so as to be incident on the HOE 32 can be made incident thereon over the entire incidence face thereof. This prevents the light emitted from the HOE 32 from having a discrete intensity distribution, and thus helps obtain an even intensity distribution.

Moreover, in each photopolymer constituting the HOEs 31 and 32, the diffraction structure with a predetermined pitch designed to diffract light of the corresponding wavelength at a predetermined angle is realized as a periodic index-of-refraction distribution in the photopolymer. Each photopolymer is several tens of microns to several hundred microns thick, and even when a plurality of layers of photopolymers are used together, they can be handled as if handling a single film material. Thus, by use of such photopolymers, the HOEs 31 and 32 can be fabricated easily.

In this embodiment, the optical waveguide member 2 has, on the faces 2a and 2b thereof on which the holographic diffractive optical elements 3 (HOEs 31 and 32) are held, surfaces that are mutually parallel and flat all over. It is however also possible to use mutually parallel curved surface in parts of the optical waveguide member 2 where the holographic diffractive optical elements 3 are not arranged, provided that total reflection conditions are fulfilled, because then the beam expanding optical element 1 functions as such. Accordingly, it can be said that the optical waveguide member 2 does not need to have flat surfaces all over the faces 2a and 2b thereof but needs to have flat surfaces at least in those parts of the faces 2a and 2b where the HOEs 31 and 32 are held.

### Embodiment 2

Another embodiment of the invention will be described below with reference to the accompanying drawings. In the following description, for the sake of convenience, such components and structures as are found also in Embodiment 1 are identified with common reference numerals and symbols, and no description thereof will be repeated.

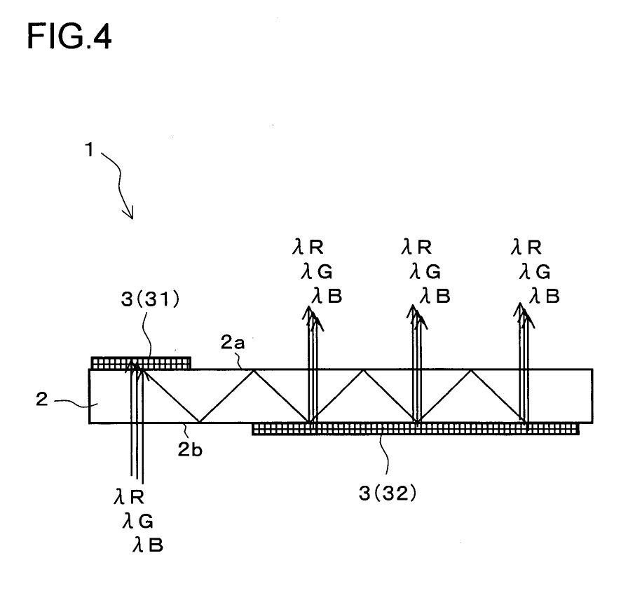

FIG. 4 is a cross-sectional view showing an outline of the structure of a beam expanding optical element 1 as a second embodiment of the invention. The beam expanding optical element 1 of this embodiment differs from that of Embodiment 1 in that, here, the HOEs 31 and 32 constituting the holographic diffractive optical elements 3 are reflective.

In this embodiment, the hologram photosensitive material of which the HOEs 31 and 32 are formed is a single layer of a photopolymer that has interference fringes corresponding to three, namely R, G, and B, wavelengths recorded therein. That is, in this embodiment, in each of the HOEs 31 and 32, an index-of-refraction distribution having a diffraction structure (interference fringes) with three different pitches so set as to diffract and thereby reflect R, G, and B light at substantially equal angles (for example, 45 degrees) is formed in a single layer by multiple exposure.

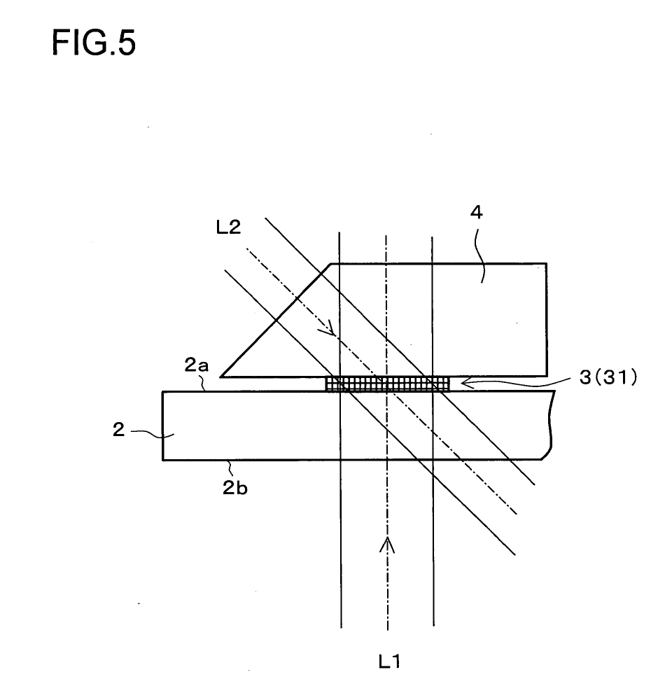

FIG. 5 is a diagram schematically illustrating part of an exposure optical system used to fabricate the holographic diffractive optical elements 3 (reflective). To fabricate the reflective HOEs 31 and 32, light is shone onto the photopolymer in a different manner than in Embodiment 1. Specifically, to fabricate a transmissive HOE, two beams L1 and L2 are shone onto a photopolymer from the same side thereof so as to interfere with each other; in contrast, to fabricate the reflective HOEs 31 and 32, two beams L1 and L2 are shone onto the photopolymer from mutually opposite sides thereof so as to interfere with each other.

The structure here is quite the same as in Embodiment 1 in various aspects, of which to name a few: the HOE 31 is designed to exhibit the maximum diffraction efficiency at the design principal wavelengths; the HOE 32 is formed with a greater width than the HOE 31 at least in the light guide direction; and the diffraction efficiency of the HOE 32 is set to be higher the farther away from the HOE 31 along the optical path.

In the structure described above, when light of R, G, and B wavelengths (λR, λG, and λB) is incident through the face 2b of the optical waveguide member 2 on the HOE 31, it is diffracted in the 45-degree direction by the HOE 31 so that it is then guided, by being totally reflected, inside the optical waveguide member 2 toward the HOE 32. Part of the light incident on the HOE 32 at an angle of 45 degrees for the first time is diffracted by the HOE 32, according to the diffraction efficiency thereof at the incidence position, so as to be emitted through the face 2a of the optical waveguide member 2 to the outside at the same angle at which light from the outside is incident on the HOE 31 (that is, the emitted light is parallel to this light from the outside); the rest of the light, left undiffracted by the HOE 32, is totally reflected by the HOE 32 so as to be further guided inside the optical waveguide member 2.

The light totally reflected by the HOE 32 is then totally reflected by the opposite face 2a of the optical waveguide member 2 so that it is then incident again on the HOE 32. In a similar manner as described above, part of the light incident on the HOE 32 is diffracted by the HOE 32, according to the diffraction efficiency thereof at the incidence position, so as to be emitted to the outside; the rest of the light, left undiffracted, is totally reflected by the HOE 32 so as to be further guided inside the optical waveguide member 2. Thereafter, each time light reaches the HOE 32, diffraction of part of the light and total reflection of the rest of the light are repeated. Thus, the beam diameter of the light emitted from the HOE 32 to the outside is expanded compared with that of the light incident from the outside on the optical waveguide member 2.

In this way, even when the HOEs 31 and 32 are reflective, as in Embodiment 1, the beam expanding optical element 1 can expand the beam diameter of incident light and then emits it to the outside.

Moreover, reflective HOEs 31 and 32 exhibit higher wavelength selectivity than transmissive HOEs, and thus can more surely diffract R, G, and B light at predetermined wavelengths. That is, the diffraction efficiency of transmissive HOEs varies more gently with wavelength; consequently, for example, a photopolymer sensitive to G light may react to R and B light, emitting it at unintended angles. In contrast, the diffraction efficiency of reflective HOEs 31 and 32 varies sharply with wavelength; consequently, R, G, and B light can be surely diffracted with photopolymers sensitive to those colors respectively.

In a case where a beam expanding optical element 1 according to the invention is used for see-through purposes as in Embodiments 4 to 6 described later, the higher the wavelength selectivity of a HOE, the more effectively it is possible to prevent the disturbance that outside light experiences when transmitted through the HOE. Accordingly, in a case where a beam expanding optical element 1 according to the invention is used for see-through purposes, it is preferable that the HOEs 31 and 32 be reflective as in this embodiment.

Moreover, in this embodiment, the hologram photosensitive material of which the HOEs 31 and 32 are formed is a single layer of a photopolymer that has interference fringes corresponding to three, namely B, R, and G, wavelengths recorded therein. This makes it possible to realize a beam expanding optical element 1 with a simpler structure than when three-layer photopolymers are used.

Of the HOEs 31 and 32 used in Embodiments 1 and 2, one may be formed of a single layer of a photopolymer and the other of three photopolymers. Needless to say, of the HOEs 31 and 32, one may be transmissive and the other reflective.

### Embodiment 3

Yet another embodiment of the invention will be described below with reference to the accompanying drawings. In the following description, for the sake of convenience, such components and structures as are found also in Embodiment 1 or 2 are identified with common reference numerals and symbols, and no description thereof will be repeated.

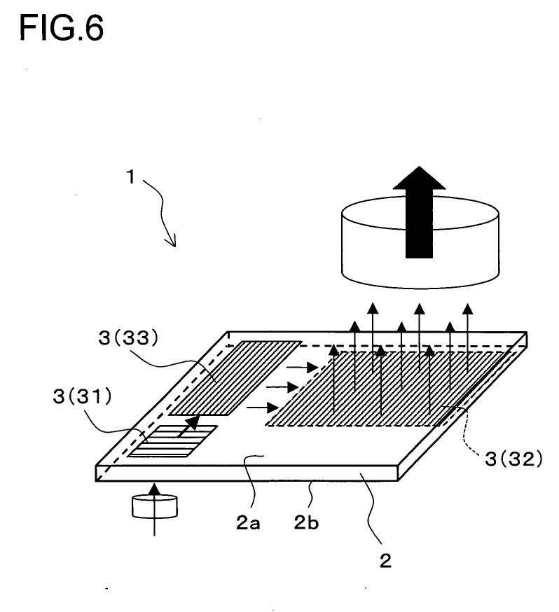

FIG. 6 is a perspective view showing an outline of the structure of a beam expanding optical element 1 as a third embodiment of the invention. In this embodiment, the holographic diffractive optical elements 3 provided in the beam expanding optical element 1 include, in addition to HOEs 31 and 32 just like those provided in Embodiment 1 or 2, a HOE 33. The HOE 33 is a third holographic diffractive optical element that diffracts the light diffracted by the HOE 31 and then traveling inside the optical waveguide member 2 such that the light is deflected toward where the HOE 32 is arranged. The HOE 33 is reflective, and is held on the face 2a or 2b of the optical waveguide member 2.

Moreover, the HOE 33 is designed to diffract, according to the diffraction efficiency thereof, part of the light incident thereon after being guided inside the optical waveguide member 2 such that this part of light is deflected, for example, at 45 degrees and is thereby directed toward where the HOE 32 is arranged, and simultaneously to totally reflect the rest of the light. The HOE 33 is formed with a greater width than the HOE 31 in the direction in which the light traveling from the HOE 31 toward the HOE 33 is guided. Thus, the light guided inside the optical waveguide member 2 and then incident on the HOE 33 includes not only the light diffracted by the HOE 31 and then incident on the HOE 33 but also the light first totally reflected by the HOE 33, then totally reflected on the opposite face of the optical waveguide member 2, and only then incident on the HOE 33.

The HOE 33 has interference fringes with three different pitches so as to diffract light of three, namely R, G, and B, wavelengths at substantially equal angles (for example, 45 degrees). The hologram photosensitive material of which the HOE 33 is formed may be three-layer photopolymers as in Embodiment 1 or a single layer of a photopolymer as in Embodiment 2.

Moreover, the diffraction efficiency of the HOE 33 is set to be higher the farther away from the HOE 31 along the optical path. The diffraction efficiency here can be set by the method described previously in connection with Embodiment 1.

In this embodiment, it is assumed that HOEs 31 and 32 are both reflective. Moreover, the HOE 32 is formed with a substantially equal width with the HOE 33 (with a greater width than the HOE 31) in the direction in which the light traveling from the HOE 31 toward the HOE 33 is guided, and with a greater width than the HOEs 31 and 33 in the direction in which the light graveling from the HOE 33 toward the HOE 32 is guided. Furthermore, the diffraction efficiency of the HOE 32 is set to be higher the farther from the HOE 31 along the optical path (in the direction from the HOE 33 to the HOE 32).

In the structure described above, when light of R, G, and B wavelengths is incident on the HOE 31, it is almost all diffracted and thereby reflected in the 45-degree direction by the HOE 31 so that it is then guided, by being totally reflected, inside the optical waveguide member 2 toward the HOE 33. Part of the light incident on the HOE 33 at an angle of 45 degrees for the first time is diffracted by the HOE 33, according to the diffraction efficiency thereof at the incidence position, toward the HOE 32. On the other hand, the light left undiffracted by the HOE 33 is totally reflected by the HOE 33 so as to be further guided inside the optical waveguide member 2.

The light totally reflected by the HOE 33 is then totally reflected on the opposite face of the optical waveguide member 2 so as to be incident again on the HOE 33. In a similar manner as described above, part of the light incident on the HOE 33 is diffracted, according to the diffraction efficiency thereof at the incidence position, toward the HOE 32; the rest of the light, left undiffracted by the HOE 33, is totally reflected by the HOE 33 so as to be further guided inside the optical waveguide member 2. Thereafter, each time light reaches the HOE 33, diffraction of part of the light and total reflection of the rest of the light are repeated. Thus, the beam diameter of the light diffracted by the HOE 33 toward the HOE 32 is expanded, in the direction of the longer sides of the HOE 33 (in the direction in which the light traveling from the HOE 31 toward the HOE 33 is guided), compared with that of the light incident from the outside on the optical waveguide member 2.

Part of the light incident from the HOE 33 on the HOE 32 at an angle of 45 degrees for the first time is diffracted by the HOE 32, according to the diffraction efficiency thereof at the incidence position, so as to be emitted to the outside at the same angle at which light from the outside is incident on the HOE 31 (that is, the emitted light is parallel to this light from the outside). On the other hand, the rest of the light, left undiffracted by the HOE 32, is totally reflected by the HOE 32 so as to be further guided inside the optical waveguide member 2. The light is then totally reflected on the opposite face of the optical waveguide member 2 so as to be incident again on the HOE 32. In a similar manner as described above, part of the light incident on the HOE 32 is diffracted by the HOE 32, according to the diffraction efficiency thereof at the incidence position, so as to be emitted to the outside; the rest of the light, left undiffracted, is totally reflected by the HOE 32 so as to be further guided inside the optical waveguide member 2. Thereafter, each time light reaches the HOE 32, diffraction of part of the light and total reflection of the rest of the light are repeated. Thus, the beam diameter of the light incident from the HOE 33 on the HOE 32 is expanded in the direction in which the light traveling from the HOE 33 toward the HOE 32 is guided.

As described above, in this embodiment, light incident from the outside is guided inside the optical waveguide member 2 so that it travels from the HOE 31 through the HOE 33 toward the HOE 32 so as to be emitted from the HOE 32 to the outside. Thus, the beam diameter of the light incident on the optical waveguide member 2 is expanded in one direction by the HOE 33 and is then expanded in another direction by the HOE 32. In this way, the beam diameter of the incident light can be expanded two-dimensionally.

Moreover, the HOE 33 diffracts, according to the diffraction efficiency thereof, part of the light incident thereon after being guided inside the optical waveguide member 2 and simultaneously totally reflects the rest of the light. Thus, in the direction in which the light traveling from the HOE 31 toward the HOE 33 is guided, diffraction and total reflection at the HOE 33 are repeated. This makes it possible to expand the beam diameter of the light incident on the optical waveguide member 2 in that light guide direction.

Moreover, the HOE 33 has interference fringes with three different pitches so as to diffract light of three, namely R, G, and B, wavelengths at substantially equal angles. Thus, even in a structure where the beam diameter is expanded two-dimensionally with the HOE 33 as in this embodiment, the emission pitch of the light emitted from the HOE 32 to the outside can be made substantially equal among light of the three different wavelengths. In this way, it is possible to reduce color unevenness in the light emitted from the HOE 32.

Moreover, the diffraction efficiency of the HOE 33 is set to be higher the farther away from the HOE 31 along the optical path. Thus, the intensity distribution of the light diffracted by the HOE 33 and then traveling toward the HOE 32 can be made even in the direction of the optical path from the HOE 31 to the HOE 33. In particular, in this embodiment, where the diffraction efficiency of the HOE 32 is set to be higher the farther away from the HOE 31 along the optical path, the intensity distribution of the light emitted from the HOE 32 to the outside can be made even not only in the direction of the optical path from the 31 to the HOE 33 but also in the direction of the optical path from the HOE 33 to the HOE 32. That is, the intensity distribution of the light emitted from the HOE 32 to the outside can be made even two-dimensionally.

### Embodiment 4

Yet another embodiment of the invention will be described below with reference to the accompanying drawings. In the following description, for the sake of convenience, such components and structures as are found also in any of Embodiments 1 to 3 are identified with common reference numerals and symbols, and no description thereof will be repeated.

In this embodiment, the beam expanding optical element 1 described previously as Embodiment 2 is applied to an image display apparatus 10. This image display apparatus 10 will be described in detail below.

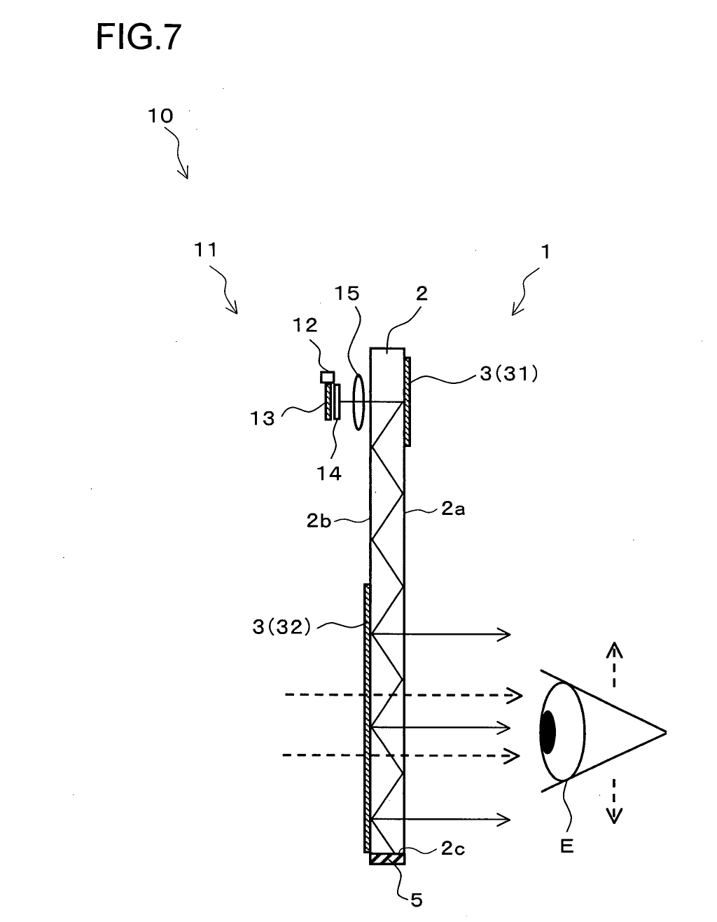

FIG. 7 is a cross-sectional view showing an outline of the structure of an image display apparatus 10 as a fourth embodiment of the invention. The image display apparatus 10 allows an observer to observe an outside image on a see-through basis, and simultaneously displays an image to present a virtual image thereof to the observer. The image display apparatus 10 includes the beam expanding optical element 1 described previously as Embodiment 2 and an image projection optical system 11. The image projection optical system 11 is provided with a light source 12, an optical waveguide plate 13, a display element 14, and an eyepiece optical system 15.

The light source 12 includes LEDs that emit light of R (red), G (green), and B (blue) respectively. The optical waveguide plate 13 guides inside it the R, G, and B light emitted from the light source 12 so that the light is incident on the display element 14 over the entire incidence face thereof. Instead of the optical waveguide plate 13, a lens may be arranged.

The display element 14 has a plurality of pixels arrayed in a matrix-like formation, and serves as a light modulating element that modulates the light emitted from the light source 12 pixel by pixel according to image data to display an image. The display element 14 is realized with, for example, a transmissive liquid crystal display element. The display element 14 may instead be a reflective liquid crystal display element, or a DMD (Digital Micromirror Device, a product of Texas Instruments Incorporated, USA).

The eyepiece optical system 15 forms the light (image light) exiting from the display element 14 into a parallel beam and directs it to the beam expanding optical element 1. The eyepiece optical system 15 is realized with, for example, an eyepiece lens. The eyepiece optical system 15 may include a plurality of lenses.

The beam expanding optical element 1 is so arranged that the image light from the image projection optical system 11 is, for example, perpendicularly incident on the HOE 31. That is, the beam expanding optical element 1 is arranged with the face 2b of the optical waveguide member 2 facing the image projection optical system 11 and the face 2a facing the observer.

The eyepiece optical system 15 has the aperture stop thereof located substantially at the position of the HOE 31. Locating the aperture stop of the eyepiece optical system 15 in this way makes it possible to exploit as an aperture stop the exterior shape of the HOE 31 or the exposure area of the HOE 31. In that case, with a small HOE 31, the image light from the display element 14 can be introduced into the optical waveguide member 2 efficiently.

With the structure described above, the R, G, and B light emitted from the light source 12 enters the optical waveguide plate 13 located next thereto so as to illuminate, as a planar light source, the display element 14. The display element 14 modulates the light incident thereon according to image data and outputs color image light. The image light is then formed into a parallel beam by the eyepiece optical system 15, and then enters the beam expanding optical element 1.

Inside the beam expanding optical element 1, the image light that has entered it through the eyepiece optical system 15 is first incident on the HOE 31, by which the light is diffracted and thereby reflected at 45 degrees toward the HOE 32 so that the light is then guided, by being totally reflected, inside the optical waveguide member 2 toward the HOE 32. One part after another of the light that has reached the HOE 32 is diffracted and thereby reflected by the HOE 32 toward the observer so that the light, now with a beam diameter expanded compared with that of the incident light, then travels toward the pupil E of the observer.

When an image display apparatus 10 is built with a beam expanding optical element 1 according to the invention as described above, even with incident light with a small beam diameter, it can be emitted toward the observer's pupil E with a larger beam diameter. Thus, even if the observer's pupil E moves, the observer can continue observing the image stably. Moreover, even with incident light with a small beam diameter, it is possible to secure a sufficiently large observation pupil. This helps make the eyepiece optical system 15 compact.

When a reflective holographic diffractive optical element, which offers high wavelength selectivity and high angle selectivity, is used as the HOE 32, the HOE 32 does not function as a diffractive element with light of wavelengths and angles that it is not designed to diffract to reflect. Thus, outside light (indicated by broken-line arrows in FIG. 7) can be directed, intact, through the HOE 32 to the observer's pupil E. This allows the image displayed on the display element 14 to be observed in a form overlaid on the outside scene; that is, it is possible to realize a so-called see-through display. Put another way, the HOE 32 here functions as a combiner that directs the image light from the display element 14 and the outside light simultaneously to the observer's pupil E, and thus the observer can observe, through the HOE 32, the image presented by the display element 14 and the outside image simultaneously.

Using a beam expanding optical element 1 according to the invention helps make the eyepiece optical system 15 compact. Thus, it is possible to realize a compact, lightweight, and in addition see-through image display apparatus 10.

By arranging the beam expanding optical element 1 such that the direction in which the beam diameter is expanded (the direction of the light traveling from the HOE 31 to the HOE 32) is aligned with the direction in which the observer's pupil E is easily movable (for example, the up/down or right/left direction with respect to the observer), it is possible to realize an image display apparatus 10 that can cope with the movement of the observer's pupil E.

This embodiment takes up an example where the beam expanding optical element 1 of Embodiment 2 is applied to an image display apparatus 10; needless to say, it is possible to apply instead the beam expanding optical element 1 of Embodiment 1 or 3 to an image display apparatus 10.

The reflective holographic diffractive optical elements 3 exhibit so high angle selectivity that, for a given single wavelength, the diffraction-efficiency half-peak angle width is about two degrees. That is, for a given single wavelength, the holographic diffractive optical elements 3 diffract and thereby reflect the image light only within an angle of view corresponding to two degrees as measured after incidence on the optical waveguide member 2. This makes it impossible to obtain a sufficient angle of view.

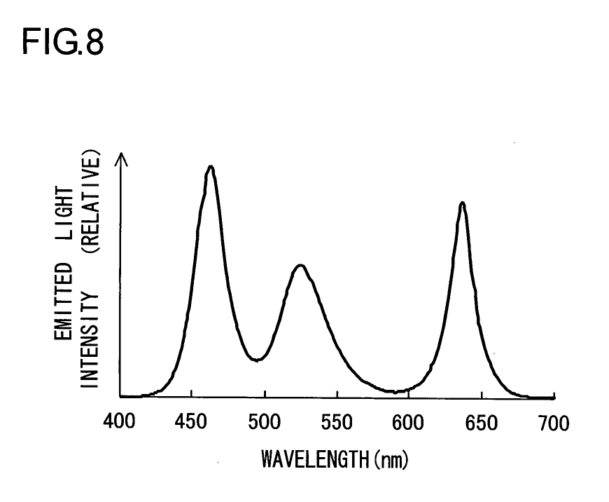

To overcome this, used as the light source 12 in this embodiment is one that emits light in a light-intensity half-peak wavelength width of 10 nm or more with respect to, and including, each principle diffraction wavelength (the wavelength at which diffraction efficiency has a peak) of all the holographic diffractive optical elements 3. More specifically, the light source 12 used has spectral intensity characteristics as shown in FIG. 8.

This light source 12 is realized with, for example, an integrated RGB LED (for example, one manufactured by Nichia Corporation) that emits light in three wavelength bands of 462±12 nm, 525±17 nm, and 635±11 nm as represented in terms of their respective peak-light-intensity wavelengths and light-intensity half-peak wavelength widths. Here, a peak-light-intensity wavelength is the wavelength at which a peak is obtained in light intensity; a light-intensity half-peak wavelength width is the wavelength width at both ends of which half the peak light intensity is obtained. In FIG. 8, light intensity is given in terms relative to 100, at which the maximum light intensity of B light is assumed to be.

When the light source 12 emits light in light-intensity half-peak wavelength widths of at least 10 nm in this way, it is possible to obtain an angle of view of approximately 10 degrees. Thus, by use of the light source 12 with the characteristics described above, even in a case where the holographic diffractive optical elements 3 exhibit high angle selectivity, it is possible to obtain an angle of view sufficient for image observation and hence for use in an image display apparatus 10.

The angle selectivity widths of the holographic diffractive optical elements 3 vary slightly depending on the indices of refraction and thicknesses of the photopolymers of which the holographic diffractive optical elements 3 are formed. Even when this is taken into consideration, it has been confirmed, when the light source 12 emits light in light-intensity half-peak wavelength widths of at least 10 nm, it is possible to obtain an angle of view sufficient for image observation.

If the light-intensity half-peak wavelength widths of the light emitted from the light source 12 are too large, the diffraction wavelength widths of the holographic diffractive optical elements 3 are too small relative to the light emission wavelength widths of the light source 12. This lowers the light use efficiency of the light emitted from the light source 12. To avoid such lowering of light use efficiency, it is preferable that the light-intensity half-peak wavelength widths of the light emitted from the light source 12 be 40 nm or less.

In the beam expanding optical element 1 shown in FIG. 7, the light ultimately left undiffracted by the HOE 32 reaches the end face 2c of the optical waveguide member 2 located in the direction in which light is guided from the HOE 31 to the HOE 32. If this light is emitted to the outside as unused light, the end face 2c lights, spoiling the exterior appearance of the image display apparatus 10. To avoid this, it is preferable to provide a light shielding member 5 on the end face 2c of the optical waveguide member 2. Providing the light shielding member 5 in this way helps prevent the light inside the optical waveguide member 2 from being emitted through the end face 2c to the outside.

Instead of providing the light shielding member 5, it is also possible to paint the end face 2c mat black to make it absorb light. This too helps prevent the light inside the optical waveguide member 2 from being emitted through the end face 2c to the outside.

### Embodiment 5

Yet another embodiment of the invention will be described below with reference to the accompanying drawings. In the following description, for the sake of convenience, such components and structures as are found also in any of Embodiments 1 to 4 are identified with common reference numerals and symbols, and no description thereof will be repeated.

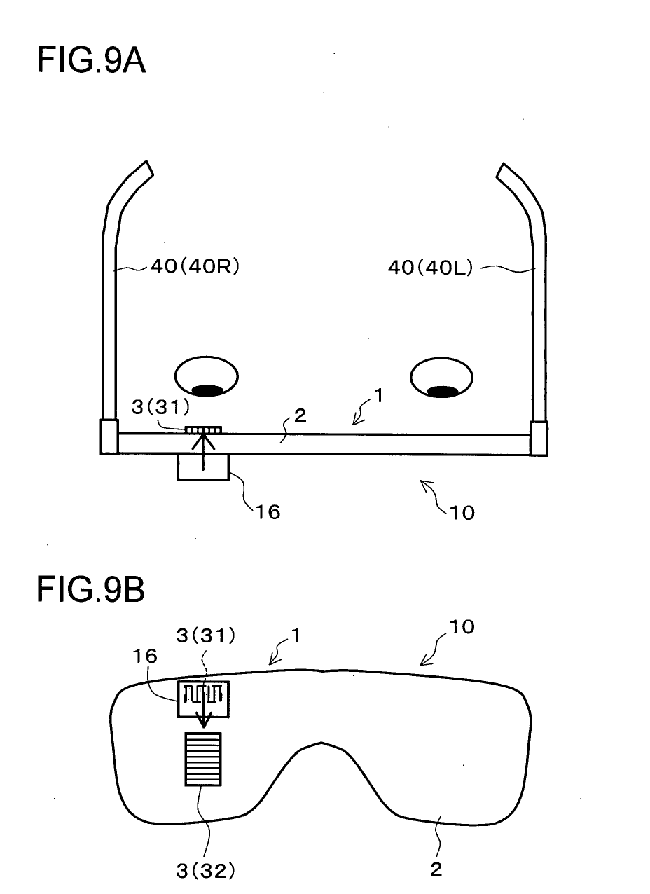

FIG. 9A is a plan view showing an outline of the structure of an HMD as a fifth embodiment of the invention, and FIG. 9B is a front view of the HMD. This HMD includes the image display apparatus 10 described above as Embodiment 4 and a supporting member 40 (supporting means). The supporting member 40 supports the image display apparatus 10 in front of an observer's eyes. The supporting member 40 includes a right temple 40R that supports the optical waveguide member 2 of the image display apparatus 10 at one end thereof and a left temple 40L that supports it at the other end thereof.

On the other hand, the components of the image projection optical system 11 are housed in a casing 16 shown in FIGS. 9A and 9B. The casing 16 is held on the optical waveguide member 2 of the beam expanding optical element 1 so as to be located in front of and above the right eye of the observer when he wears the HMD.

When the observer uses the HMD, he wears it on his head as if wearing ordinary spectacles, with the right and left temples 40R and 40L touching right and left side portions of the head. In this state, when an image is displayed on the display element 14 (see FIG. 7) of the image display apparatus 10, the observer can observe a virtual image of the displayed image, while simultaneously observing the outside image through the image display apparatus 10 in a see-through fashion.

As described above, the HMD of this embodiment has the image display apparatus 10 supported by the supporting member 40. This allows the observer to observe the image presented by the image display apparatus 10 and the outside image in a hands-free fashion.

### Embodiment 6

Yet another embodiment of the invention will be described below with reference to the accompanying drawings. In the following description, for the sake of convenience, such components and structures as are found also in any of Embodiments 1 to 5 are identified with common reference numerals and symbols, and no description thereof will be repeated.

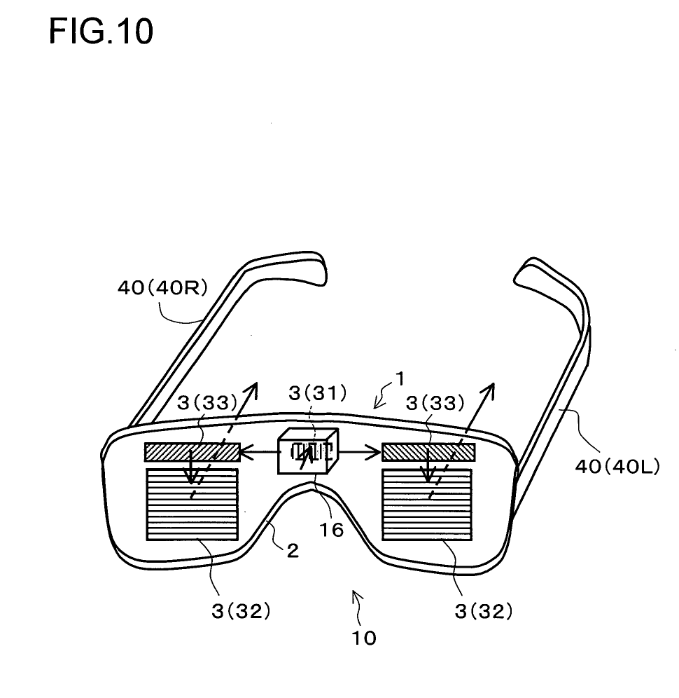

FIG. 10 is a perspective view showing an outline of the structure of an HMD as a sixth embodiment of the invention. This HMD includes an image display apparatus 10 built, for incorporation in an HMD, with the beam expanding optical element 1 of Embodiment 3 and the image projection optical system 11 of Embodiment 4. Here, the HMD is so structured that the observer can observe the image displayed on the display element 14 of the image projection optical system 11 with both eyes. The casing 16 in which the components of the image projection optical system 11 are housed is held on the optical waveguide member 2 so as to be located between the observer's eyes when he wears the HMD.

The beam expanding optical element 1 shown in FIG. 10 includes, as the holographic diffractive optical elements 3, one HOE 31, two HOEs 32, and two HOEs 33. The HOE 31 is held on the surface of the optical waveguide member 2, at a position thereon corresponding to between the observer's eyes. The HOE 31 diffracts light incident from the outside thereon such that it then travels toward both of the HOEs 33.

One pair of HOEs 32 and 33 is arranged on the surface of the optical waveguide member 2, at the position thereon corresponding to the observer's right eye; the other pair of HOEs 32 and 33 is arranged on the surface of the optical waveguide member 2, at the position thereon corresponding to the observer's left eye. Each HOE 33 diffracts the light diffracted by the HOE 31 and then traveling inside the optical waveguide member 2 toward where the corresponding HOE 32 is arranged.

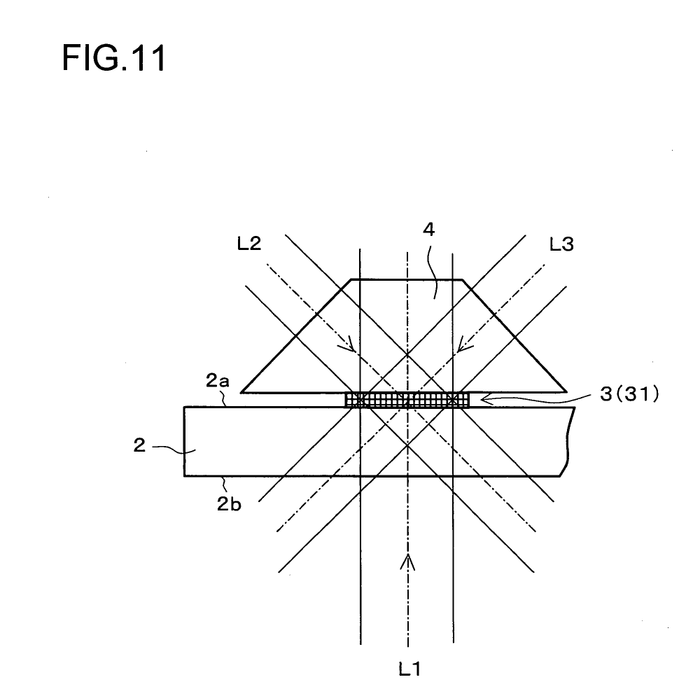

In this embodiment, the HOE 31 is fabricated as follows. FIG. 11 is a diagram schematically illustrating part of an exposure optical system used to fabricate the HOE 31. To fabricate the reflective HOE 31, light emitted from R, G, and B laser light sources (unillustrated) is mixed into a single beam, and is then split into three beams L1, L2, and L3. The beam L1 is shone onto a photopolymer from one side thereof, and the other two beams L1 and L2 are shone onto the photopolymer from the other side thereof, so that the three beams interfere with one another. Here, the direction of incidence of the beam L1 is perpendicular to the faces 2a and 2b of the optical waveguide member 2; on the other hand, the directions of incidence of the beams L2 and L3 are at an angle of 45 degrees to the faces 2a and 2b of the optical waveguide member 2, and the beams L2 and L3 are perpendicular to each other.

With the structure described above, the light emitted from the light source 12 provided in the casing 16 is modulated by the display element 14 and is emitted therefrom as image light, which is then directed through the eyepiece optical system 15 to the beam expanding optical element 1. Then, in the beam expanding optical element 1, the HOE 31 diffracts the light incident from the image projection optical system 11 thereon such that it then travels toward both of the HOEs 33, and then each HOE 33 diffracts the light diffracted by the HOE 31 and then traveling inside the optical waveguide member 2 such that it then travels toward where the corresponding HOE 32 is arranged. Then, each HOE 32 emits the image light, now with the beam diameter thereof expanded two dimensionally compared with that of the incident light.

As described above, in the HMD of this embodiment, the image light is emitted in a form two-dimensionally expanded. Thus, even if the observer's pupil deviates two-dimensionally, the observer can observe the image easily according to where the pupil is actually located. Moreover, even when the beam diameter of the light before entering the beam expanding optical element 1 is small, it is possible to secure a sufficiently large observation pupil, and thus it is possible to make the eyepiece optical system 15 compact. Moreover, the HOEs 32, from which the image light is eventually emitted, are arranged at positions on the optical waveguide member 2 corresponding to both eyes of the observer, and thus it is possible to obtain the previously mentioned effects of the invention in an image display apparatus that permits image observation with both eyes.

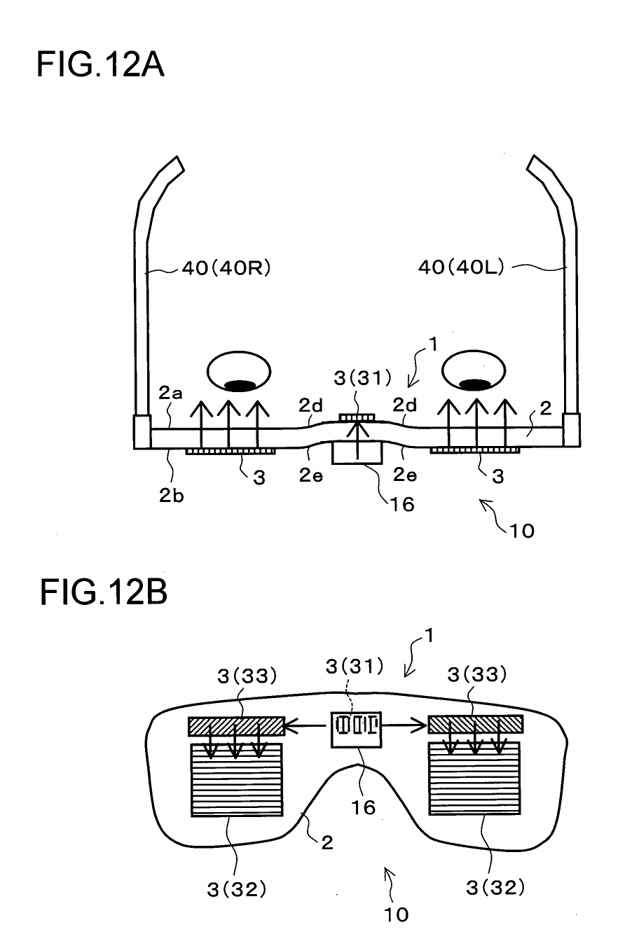

The description thus far deals with cases where the faces 2a and 2b (see FIG. 11) of the beam expanding optical element 1 are flat overall; the faces 2a and 2b, however, do not necessarily have to be flat allover. For example, FIG. 12A is a plan view showing another example of the structure of the HMD of this embodiment, and FIG. 12B is a plan view of the HMD so structured. In this HMD, parts of the faces 2a and 2b of the optical waveguide member 2 located between the parts thereof where HOEs 31 and 33 are held are formed into mutually parallel curved surfaces 2d and 2e. What is important here is that these curved surfaces 2d and 2e are given such a curvature as to totally reflect all the image light.

Forming parts of the mutually opposite faces 2a and 2b of the optical waveguide member 2 into mutually parallel curved surfaces 2d and 2e that have a curvature fulfilling total reflection conditions helps increase flexibility in the design of the optical waveguide member 2, and makes it possible to realize an image display apparatus 10 and an HMD with a sophisticated design.

Needless to say, different aspects of the different structures of the embodiments described above may be combined together appropriately to build a beam expanding optical element 1, an image display apparatus 10, and an HMD with structures different from those specifically described above.

Beam expanding optical elements and image display apparatuses 10 according to the invention find applications not only in HMDs as described above but also in, for example, head-up displays and other displays, compact beam expanders, and illuminating apparatuses for flat-panel displays.

The present invention may alternatively be expressed as follows, leading to workings and effects noted below.

According to an aspect of the invention, a beam expanding optical element that expands the beam diameter of the light incident thereon and then emits it includes: an optical waveguide member that has two mutually opposite faces that respectively have mutually parallel flat surfaces; and a plurality of holographic diffractive optical elements held at different locations on the flat surfaces of the optical waveguide member, with at least one of the holographic diffractive optical elements located on one of the flat surfaces and at least another of the holographic diffractive optical elements located on the other of the flat surfaces. The holographic diffractive optical elements include: a first holographic diffractive optical element that diffracts light incident from the outside on the optical waveguide member such that the light is then totally reflected inside the optical waveguide member; and a second holographic diffractive optical element that diffracts, according to the diffraction efficiency thereof, part of the light incident thereon after being guided inside the optical waveguide member such that this part of the light is then emitted to the outside substantially parallel to the light incident on the optical waveguide member, the second holographic diffractive optical element simultaneously totally reflecting the rest of the light incident thereon. Here, let n be a natural number equal to or greater than 2, the first and second holographic diffractive optical elements each have interference fringes with n different pitches so as to diffract light of n different wavelengths at substantially equal angles.

As a result of the first and second holographic diffractive optical elements each having interference fringes with n different pitches (where n is a natural number equal to or greater than two) so as to diffract light of n different wavelengths at substantially equal angles in this way, even when light of n different wavelengths is incident on the optical waveguide member, the emission pitch of the light emitted from the second holographic diffractive optical element to the outside is substantially equal among light of the n different wavelengths. Hence, with a simple structure involving a plurality of holographic diffractive optical elements bonded to a single optical waveguide member, and in addition at low cost, it is possible to reduce color unevenness.

According to the invention, preferably, the second holographic diffractive optical element further diffracts, according to the diffraction efficiency thereof, part of the light incident again thereon after being totally reflected once thereby and then totally reflected from the opposite flat surface such that this part of the light is then emitted to the outside substantially parallel to the light incident on the optical waveguide member, the second holographic diffractive optical element simultaneously totally reflecting the rest of the light incident again thereon.

In that case, emission of light to the outside and total reflection are repeated at the second holographic diffractive optical element, permitting the beam diameter of the light emitted from the second holographic diffractive optical element to the outside to be surely expanded compared with the light incident from the outside on the optical waveguide member.

According to the invention, preferably, the second holographic diffractive optical element has higher diffractive efficiency the farther away from the first holographic diffractive optical element along the optical path. In that case, the intensity distribution of the light emitted from the second holographic diffractive optical element to the outside is even in the direction of the optical path from the first holographic diffractive optical element to the second holographic diffractive optical element.

According to the invention, preferably, the first holographic diffractive optical element is formed a width greater than the pitch with which the light is emitted from the second holographic diffractive optical element to the outside. In that case, for example, when light with a beam diameter substantially equal to the width of the first holographic diffractive optical element is incident thereon, the light emitted from the second holographic diffractive optical element to the outside is prevented from having an uneven intensity distribution (with high-intensity positions appearing discretely). Thus, it is possible to make the intensity distribution of the emitted light even.

According to the invention, the holographic diffractive optical elements may further include: a third holographic diffractive optical element that diffracts the light diffracted by the first holographic diffractive optical element and then traveling inside the optical waveguide member such that the light is deflected toward where the second holographic diffractive optical element is arranged.

With this structure, the light diffracted by the first holographic diffractive optical element and then traveling inside the optical waveguide member is deflected by the third holographic optical element so that the light then further travels inside the optical waveguide member to be incident on the second holographic diffractive optical element. Thus, inside the optical waveguide member, the direction in which light is guided from the first holographic diffractive optical element to the third holographic optical element differs from the direction in which light is guided from the third holographic optical element to the second holographic diffractive optical element. This makes it possible to expand the beam diameter of the light incident on the optical waveguide member in one direction with the third holographic optical element and in another direction with the second holographic diffractive optical element. Thus, it is possible to expand the beam diameter of the incident light two-dimensionally.

According to the invention, preferably, the third holographic diffractive optical element diffracts, according to diffraction efficiency thereof, part of the light incident thereon after being guided inside the optical waveguide member such that this part of the light is then directed toward where the second holographic diffractive optical element is arranged, the third holographic diffractive optical element simultaneously totally reflecting the rest of the light incident thereon.

In that case, in the direction in which light is guided from the first holographic diffractive optical element to the third holographic optical element, diffraction and total reflection are repeated at the third holographic optical element. This permits the beam diameter of the light incident on the optical waveguide member to be expanded in that light guide direction.

According to the invention, preferably, the third holographic diffractive optical element further diffracts, according to diffraction efficiency thereof, part of the light incident again thereon after being totally reflected once thereby and then totally reflected from the opposite flat surface such that this part of the light is then directed toward where the second holographic diffractive optical element is arranged, the third holographic diffractive optical element simultaneously totally reflecting the rest of the light incident again thereon

In that case, in the direction in which light is guided from the first holographic diffractive optical element to the third holographic diffractive optical element, diffraction and total reflection are repeated at the third holographic optical element. This permits the beam diameter of the light incident on the optical waveguide member to be surely expanded in that light guide direction.

According to the invention, preferably, the third holographic diffractive optical element has interference fringes with n different pitches so as to diffract light of the n different wavelengths at substantially equal angles. In that case, even in a structure where the beam diameter is expanded two-dimensionally with the third holographic optical element, the emission pitch of the light emitted from the second holographic diffractive optical element to the outside can be made substantially equal among light of the three different wavelengths. Thus, it is possible to reduce color unevenness.

According to the invention, preferably, the third holographic diffractive optical element has higher diffractive efficiency the farther away from the first holographic diffractive optical element along the optical path. In that case, the intensity distribution of the light diffracted by the third holographic optical element and then traveling toward the second holographic diffractive optical element can be made even in the direction of the optical path from the first holographic diffractive optical element toward the third holographic optical element.

Here, when the second holographic diffractive optical element also has higher diffractive efficiency the farther away from the first holographic diffractive optical element along the optical path, the intensity distribution of the light emitted from the second holographic diffractive optical element to the outside can be made even both in the direction of the optical path from the first holographic diffractive optical element toward the third holographic optical element and in the direction of the optical path from the third holographic diffractive optical element toward the second holographic optical element.

According to the invention, at least one of the holographic diffractive optical elements may be composed of n layers of photopolymers laid together that have interference fringes recorded therein corresponding to the n different wavelengths respectively. In that case, a holographic diffractive optical element can be fabricated by laying together n layers of sheet-form photopolymers as hologram photosensitive materials, and thus a holographic diffractive optical element having the above-mentioned characteristics can be fabricated easily.

According to the invention, at least one of the holographic diffractive optical elements may be composed of one layer of a photopolymer that has interference fringes recorded therein corresponding to the n different wavelengths. In that case, a holographic diffractive optical element can be fabricated with a single layer of a photopolymer as a hologram photosensitive material, and thus a holographic diffractive optical element having the above-mentioned characteristics can be fabricated more easily.

According to another aspect of the invention, an image display apparatus may include: the above-described beam expanding optical element according to the invention; a light source that emits light; a display element that displays an image by modulating the light emitted from the light source; and an eyepiece optical system that directs the image light from the display element to the beam expanding optical element.

With this structure, the light emitted from the light source is modulated by the display element so as to be emitted as image light, which is then directed through the eyepiece optical system to the beam expanding optical element. The beam expanding optical element then emits the image light, now with a beam diameter expanded compared with that of the incident light. Thus, even when the beam diameter before entry into the beam expanding optical element is small, it is possible to secure a sufficiently large observation pupil, and thus it is possible to make the eyepiece optical system compact. Moreover, since the image light is emitted with the beam diameter thereof expanded compared with that of the incident light, the observer can observe the image according to where the pupil is actually located.

According to another aspect of the invention, an image display apparatus may include: the above-described beam expanding optical element according to the invention (the one including the third holographic optical element); a light source that emits light; a display element that displays an image by modulating the light emitted from the light source; and an eyepiece optical system that directs the image light from the display element to the beam expanding optical element. Here, the beam expanding optical element may include two second holographic diffractive optical elements and two third holographic diffractive optical elements so that, while the first holographic diffractive optical element diffracts the light incident from the outside such that it then travels toward both of the two third holographic optical elements, each third holographic optical element diffracts the light diffracted by the first holographic diffractive optical element and then traveling inside the optical waveguide member so that the light then travels toward where the corresponding second holographic diffractive optical element is arranged.

With this structure, the light emitted from the light source is modulated by the display element so as to be emitted as image light, which is then directed through the eyepiece optical system to the beam expanding optical element. The beam expanding optical element then emits the image light, now with a beam diameter expanded two-dimensionally compared with that of the incident light. Thus, even when the beam diameter before entry into the beam expanding optical element is small, it is possible to secure a sufficiently large observation pupil, and thus it is possible to make the eyepiece optical system, and hence the apparatus as a whole, compact. Moreover, since the image light is emitted with the beam diameter thereof expanded two-dimensionally compared with that of the incident light, the observer can observe the image according to where the pupil is actually located.

Moreover, since the first holographic diffractive optical element diffracts the light incident from the outside such that it then travels toward both of the two third holographic optical elements, and each third holographic optical element diffracts the light diffracted by the first holographic diffractive optical element and then traveling inside the optical waveguide member so that the light then travels toward where the corresponding second holographic diffractive optical element is arranged, when the second holographic diffractive optical elements are arranged at positions corresponding to both eyes of the observer, it is possible to obtain the previously mentioned effects of the invention in an image display apparatus that permits image observation with both eyes.

According to the invention, in the beam expanding optical element, the second holographic diffractive optical element may be a combiner that directs the image light from the display element and the outside light simultaneously to the observer's eye. In that case, the observer can observe, through the second holographic diffractive optical element, the image presented by the display element and the outside image simultaneously. Moreover, since using a beam expanding optical element according to the invention helps make the eyepiece optical system compact, it is possible to realize a compact, lightweight, and in addition see-through image display apparatus.

According to the invention, preferably, the position of the aperture stop of the eyepiece optical system substantially coincides with the position of the first holographic diffractive optical element of the beam expanding optical element. In that case, with a small first holographic diffractive optical element, the image light from the display element can be introduced into the optical waveguide member efficiently.

According to the invention, preferably, the light source emits light whose light-intensity half-peak wavelength width is 10 nm or more with respect to, and including, the peak-diffraction-efficiency wavelengths of the holographic diffractive optical elements. In that case, even when holographic diffractive optical elements with high angle selectivity are used, it is possible to obtain an angle of view sufficient for image observation.

According to the invention, the two mutually opposite faces of the optical waveguide member of the beam expanding optical element may respectively have mutually parallel curved surfaces with a curvature fulfilling total reflection conditions. This helps increase flexibility in the design of the optical waveguide member, and makes it possible to realize an image display apparatus with a sophisticated design. Even when parts of the optical waveguide member other than the flat-surfaced parts thereof for holding the holographic diffractive optical elements are formed into mutually opposite, mutually parallel curved surfaces, provided that total reflection conditions are fulfilled, it is possible to realize a beam expanding optical element according to the invention.

According to another aspect of the invention, a head-mounted display includes: the above-described image display apparatus according to the invention; and supporting means for supporting the image display apparatus in front of an observer's eye. With this structure, since the image display apparatus is supported by supporting means, the observer can observe the image presented by the image display apparatus in a hands-free fashion.

Obviously, many modifications and variations of the present invention are possible in light of the above teachings. It is therefore to be understood that within the scope of the appended claims, the invention may be practiced other than as specifically described.

What is claimed is:

1. A beam expanding optical element, comprising:
an optical waveguide member that has two mutually opposite faces that respectively have mutually parallel flat surfaces;
a first holographic diffractive optical element arranged at one location on the flat surface of the optical waveguide member, the first holographic diffractive optical element diffracting light incident from outside on the optical waveguide member such that the light is then totally reflected inside the optical waveguide member; and
a second holographic diffractive optical element arranged at another location on the flat surface of the optical waveguide member, the second holographic diffractive optical element diffracting, according to diffraction efficiency thereof, part of the light incident thereon after being guided inside the optical waveguide member such that this part of the light is then emitted to outside substantially parallel to the light incident on the optical waveguide member, the second holographic diffractive optical element simultaneously totally reflecting the rest of the light incident thereon,
wherein the first and second holographic diffractive optical elements each have interference fringes with n different pitches (where n is a natural number equal to or greater than two) so as to diffract light of n different wavelengths at substantially equal angles.

2. The beam expanding optical element according to claim 1,
wherein the second holographic diffractive optical element further diffracts, according to diffraction efficiency thereof, part of the light incident again thereon after being totally reflected once thereby and then totally reflected from the opposite flat surface such that this part of the light is then emitted to outside substantially parallel to the light incident on the optical waveguide member, the second holographic diffractive optical element simultaneously totally reflecting the rest of the light incident again thereon.

3. The beam expanding optical element according to claim 1,
wherein the second holographic diffractive optical element has higher diffractive efficiency the farther away from the first holographic diffractive optical element along an optical path.

4. The beam expanding optical element according to claim 1,
wherein the first holographic diffractive optical element has a width greater than a pitch with which the light is emitted from the second holographic diffractive optical element to outside.

5. The beam expanding optical element according to claim 1, further comprising:
a third holographic diffractive optical element that diffracts the light diffracted by the first holographic diffractive optical element and then traveling inside the optical waveguide member such that the light is deflected toward where the second holographic diffractive optical element is arranged.

6. The beam expanding optical element according to claim 5,
wherein the third holographic diffractive optical element diffracts, according to diffraction efficiency thereof, part of the light incident thereon after being guided inside the optical waveguide member such that this part of the light is then directed toward where the second holographic diffractive optical element is arranged, the third holographic diffractive optical element simultaneously totally reflecting the rest of the light incident thereon,

7. The beam expanding optical element according to claim 5,
wherein the third holographic diffractive optical element further diffracts, according to diffraction efficiency thereof, part of the light incident again thereon after being totally reflected once thereby and then totally reflected from the opposite flat surface such that this part of the light is then directed toward where the second holographic diffractive optical element is arranged, the third holographic diffractive optical element simultaneously totally reflecting the rest of the light incident again thereon.

8. The beam expanding optical element according to claim 5,
wherein the third holographic diffractive optical element has interference fringes with n different pitches so as to diffract light of the n different wavelengths at substantially equal angles.

9. The beam expanding optical element according to claim 5,
wherein the third holographic diffractive optical element has higher diffractive efficiency the farther away from the first holographic diffractive optical element along an optical path.

10. The beam expanding optical element according to claim 1,
wherein at least one of the first and second holographic diffractive optical elements is composed of n layers of photopolymers laid together that have interference fringes recorded therein corresponding to the n different wavelengths respectively.

11. The beam expanding optical element according to claim 1,
wherein at least one of the first and second holographic diffractive optical elements is composed of one layer of a photopolymer that has interference fringes recorded therein corresponding to the n different wavelengths.

12. An image display apparatus, comprising:
a light source;
a display element that produces image light by modulating light emitted from the light source;
the beam expanding optical element according to claim 1; and
an optical system that directs the image light from the display element to the beam expanding optical element.

13. The image display apparatus according to claim 12,
wherein the second holographic diffractive optical element is a combiner that directs the image light from the display element and outside light simultaneously to an observer's eye.

14. The image display apparatus according to claim 12,
wherein a position of an aperture stop of the optical system substantially coincides with a position of the first holographic diffractive optical element.

15. The image display apparatus according to claim 12,
wherein the light source emits light whose light-intensity half-peak wavelength width is 10 nm or more with respect to, and including, at least one peak-diffraction-efficiency wavelength of the first and second holographic diffractive optical elements.

16. The image display apparatus according to claim 12,
wherein the two mutually opposite faces of the optical waveguide member respectively have mutually parallel curved surfaces with a curvature fulfilling total reflection conditions.

17. A head-mounted display, comprising:
the image display apparatus according to claim 12; and
a supporting member that supports the image display apparatus in front of an observer's eye.

18. An image display apparatus, comprising:
a light source;
a display element that produces image light by modulating light emitted from the light source;
the beam expanding optical element according to claim 5; and
an optical system that directs the image light from the display element to the beam expanding optical element,
wherein the beam expanding optical element comprises two second holographic diffractive optical elements and two third holographic diffractive optical elements,
wherein the first holographic diffractive optical element diffracts the light incident from the display element thereon such that the light is then directed toward both of the two third holographic diffractive optical elements, and
wherein the third holographic diffractive optical elements respectively diffract the light diffracted by the first holographic diffractive optical element and then traveling inside the optical waveguide member such that the light is then directed toward where the corresponding second holographic diffractive optical elements are arranged.

19. The image display apparatus according to claim 18,
wherein the second holographic diffractive optical elements are each a combiner that directs the image light from the display element and outside light simultaneously to an observer's eye.

20. The image display apparatus according to claim 18,
wherein a position of an aperture stop of the optical system substantially coincides with a position of the first holographic diffractive optical element.

21. The image display apparatus according to claim 18,
wherein the light source emits light whose light-intensity half-peak wavelength width is 10 nm or more and includes at least one peak-diffraction-efficiency wavelength of the first, second, and third holographic diffractive optical elements.

22. The image display apparatus according to claim 18,
wherein the two mutually opposite faces of the optical waveguide member respectively have mutually parallel curved surfaces with a curvature fulfilling total reflection conditions.

23. A head-mounted display, comprising:
the image display apparatus according to claim 18; and
a supporting member that supports the image display apparatus in front of an observer's eye.

24. A method for beam expansion, comprising:
a step of diffracting, by using a first holographic diffractive optical element arranged on a flat surface on an optical waveguide member, light of n different wavelengths (where n is a natural number equal to or greater than two) incident thereon at substantially equal angles;
a step of totally reflecting the light diffracted by the first holographic diffractive optical element so as to make the light travel inside the optical waveguide member; and
a step of receiving the light traveling inside the optical waveguide member with a second holographic diffractive optical element so that the second holographic diffractive optical element
diffracts part of the light so as to emit this part of the light to outside substantially parallel to incident light and
simultaneously totally reflect the rest of the light,
the second holographic diffractive optical element diffracting the light of the n different wavelengths at substantially equal angles.
